(19) United States
(12) Patent Application Publication
(10) Pub. No.: US 2023/0177069 A1
(43) Pub. Date: Jun. 8, 2023

(54) EFFICIENT JOURNAL LOG RECORD FOR COPY-ON-WRITE B+ TREE OPERATION

(71) Applicant: VMware, Inc., Palo Alto, CA (US)

(72) Inventors: Enning Xiang, San Jose, CA (US); Wenguang Wang, Santa Clara, CA (US); Junlong Gao, Vancouver (CA); Hardik Singh Negi, Sunnyvale, CA (US); Yanxing Pan, San Jose, CA (US); Pranay Singh, San Ramon, CA (US); Yifan Wang, San Jose, CA (US)

(21) Appl. No.: 17/643,268

(22) Filed: Dec. 8, 2021

(51) Int. Cl. G06F 16/27; G06F 16/22

(52) U.S. Cl. CPC G06F 16/27; G06F 16/2246

(57) ABSTRACT

A method for copy on write (COW) operations generally includes receiving a write request to a first node in an ordered data structure and updating a write ahead log record associated with COW operation with, instead of the content of the first node, a physical disk address of a second node owned by the run point in the ordered data structure that is a parent node of the first node, a pointer to the first node in the second node, a physical disk address of the first node, and a physical disk address of the third node. A metadata table record for a snapshot that owns the first node may be updated with a log sequence number (LSN) of the COW operation. A method for deleting a snapshot includes determining whether the COW operation recorded in the WAL record for the LSN is completed before deleting the snapshot.

### BACKGROUND

In the field of data storage, a storage area network (SAN) is a dedicated, independent high-speed network that interconnects and delivers shared pools of storage devices to multiple servers. A virtual SAN (VSAN) may aggregate local or direct-attached data storage devices, to create a single storage pool shared across all hosts in a host cluster. This pool of storage (sometimes referred to herein as a “datastore” or “data storage”) may allow virtual machines (VMs) running on hosts in the host cluster to store virtual disks that are accessed by the VMs during their operations. The VSAN architecture may be a two-tier datastore including a performance tier for the purpose of read caching and write buffering and a capacity tier for persistent storage.

The VSAN datastore may manage storage of virtual disks at a block granularity. For example, VSAN may be divided into a number of physical blocks (e.g., 4096 bytes or “4K” size blocks), each physical block having a corresponding physical block address (PBA) that indexes the physical block in storage. Physical blocks of the VSAN may be used to store blocks of data (also referred to as data blocks) used by VMs, which may be referenced by logical block addresses (LBAs). Each block of data may have an uncompressed size corresponding to a physical block. Blocks of data may be stored as compressed data or uncompressed data in the VSAN, such that there may or may not be a one to one correspondence between a physical block in VSAN and a data block referenced by an LBA.

Modem storage platforms, including the VSAN datastore, may enable snapshot features for backup, archival, or data protections purposes. Snapshots provide the ability to capture a point-in-time state and data of a VM to not only allow data to be recovered in the event of failure but restored to known working points. Snapshots may not be stored as physical copies of all data blocks, but rather may entirely, or in part, be stored as pointers to the data blocks that existed when the snapshot was created.

Each snapshot may include its own snapshot metadata, e.g., mapping of LBAs mapped to PBAs, stored concurrently by several compute nodes (e.g., metadata servers). The snapshot metadata may be stored as key-value data structures to allow for scalable input/output (I/O) operations. In particular, a unified logical map B+ tree may be used to manage logical extents for the logical address to physical address mapping of each snapshot, where an extent is a specific number of contiguous data blocks allocated for storing information. A B+ tree is a multi-level data structure having a plurality of nodes, each node containing one or more key-value pairs stored as tuples (e.g., <key, value>). A key is an identifier of data and a value is either the data itself or a pointer to a location (e.g., in memory or on disk) of the data associated with the identifier.

In certain embodiments, the logical map B+ tree may be a copy-on-write (COW) B+ tree (also referred to as an append-only B+ tree). COW techniques improve performance and provide time and space efficient snapshot creation by only copying metadata about a node where the original data is stored, as opposed to creating a physical copy of the data, when a snapshot is created. When a COW approach is taken and a new child snapshot is to be created, instead of copying the entire logical map B+ tree of the parent snapshot, the child snapshot shares with the parent, and sometimes ancestor snapshots, one or more extents, meaning one or more nodes, by having a B+ tree index node, exclusively owned by the child snapshot. The index node of the new child snapshot includes pointers (e.g., index values) to child nodes, which initially are nodes shared with the parent snapshot. For a write operation, a shared node, which is shared between the parent snapshot and the child snapshot, requested to be overwritten by the COW operation may be referred to as a source shared node. Before executing the write, the source shared node is copied to create a new node, owned by the run point (e.g., the child snapshot), and the write is then executed to the new node in the run point.

To guarantee data validity of B+ tree changes, a write-ahead-log (WAL) may be used. A WAL provides atomicity and durability guarantees in storage by persisting each transaction of B+ tree changes as a command to an append-only log before they are written to storage. For example, client requests to write data to storage may be processed by recording the received client write request in the WAL (e.g., as a log record). WAL records can be replayed for recovery from crashes. To record a COW write operation in the WAL, the content of the source shared node for the COW write operation may be copied to the WAL, but may not be copied to the run point until a write I/O request is received to overwrite the source shared node. The typical size of a B+ tree node is one page (e.g., 4 KB). Thus, the overhead of the COW operation may be large compared to normal B+ tree operations.

Accordingly, there is a need in the art for improved techniques for COW B+ tree operation. Such improved techniques may be efficient and reduce overhead of the WAL for COW B+ tree operations.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1 is a diagram illustrating an example computing environment in which embodiments of the present application may be practiced.

FIG. 2 is a block diagram illustrating an example snapshot hierarchy, according to an example embodiment of the present disclosure.

FIG. 3 illustrates an example B+ tree data structure, according to an example embodiment of the present disclosure.

FIG. 4 illustrates an example B+ tree data structure using a copy-on-write (COW) approach for the creation of logical map B+ trees for child snapshots in a snapshot hierarchy, according to an example embodiment of the present application.

FIG. 5A is an example work flow for a COW B+ tree operation, according to an example embodiment of the present application.

FIG. 5B is an example work flow for deleting a snapshot in a COW B+ tree, according to an example embodiment of the present application.

FIG. 5C is another example work flow for deleting a snapshot in a COW B+ tree, according to an example embodiment of the present application.

FIG. 5D is another example work flow for deleting a snapshot in a COW B+ tree, according to an example embodiment of the present application.

FIG. 6A illustrates an example run point and parent snapshot before executing a COW operation, according to an example embodiment of the present application.

FIG. 6B illustrates an example run point and parent snapshot after executing a COW operation, according to an example embodiment of the present application.

FIG. 7 is a block diagram illustrating an example COW B+ tree metadata table, according to an example embodiment of the present disclosure.

FIG. 8 is a block diagram illustrating an example COW B+ tree WAL, according to an example embodiment of the present disclosure.

### DETAILED DESCRIPTION

Aspects of the present disclosure introduce techniques for COW B+ tree operations. When a new child snapshot is to be created, instead of copying the entire logical map B+ tree of the parent snapshot, the child snapshot shares one or more extents with the parent (or other ancestor snapshots) by having a B+ tree index node, exclusively owned by the child snapshot, that point to a shared node in the parent and/or other ancestor snapshot.

Conventionally, when a write request is received to overwrite a shared node in a COW B+ tree, the content of the shared node is copied out to the WAL. The typical size of a B+ tree node is one page (e.g., 4 KB) and, thus, the overhead of the COW operation may be large compared to normal B+ tree operations. The size of the WAL can be reduced by only recording the physical disk address (e.g., the PBA) of the source shared node, instead of copying the content of the source shared node to the WAL. However, if the source shared node page is deleted, such as during snapshot deletion, the data may be lost.

Aspects of the present disclosure may allow efficient copying of a source shared node to a WAL record for a COW B+ tree operation, while maintaining data correctness for log replay in crash recovery.

In some embodiments, instead of storing the content of a source shared node, the WAL stores physical disk address information associated with the nodes involved in the COW operation. In some embodiments, the WAL includes tuples of the COW B+ tree including the physical disk address of a parent node, in the run point, of the source shared node (“parentNodeAddr”), one or more pointers to one or more child nodes of the parent node including a pointer to the source shared node(“childIndexInParent”), the physical disk address of the new run point node created by copying the source shared node (“newChildNodeAddr”), and the physical disk address of the source shared node (“srcChildNodeAddr”). Accordingly, the size of the WAL record for the source shared node can be reduced from the size of a page (e.g., 4 KB) to the size of the tuple (e.g., <parentNodeAddr, childIndexInParent, newChildNodeAddr, srcChildNodeAddr>) which may be, for example, less than 20 bytes).

In some embodiments, the system maintains a metadata table for each snapshot. In some embodiments, the metadata table is implemented by a persistent key-value store, such as a COW B+ tree. The metadata table includes, for each snapshot, a snapshot record identified by a snapshot identifier (ID). Each WAL record may be associated with a monotonically increasing log sequence number (LSN). In some embodiments, the LSN of a last COW operation (e.g., “lastCOWLSN”) is included in the metadata table at the snapshot record for the parent or ancestor snapshot that owns the source shared node page of the COW operation (e.g., to be overwritten by the COW operation).

The WAL may be replayed, such as in the event of a crash. For example, a run point may be restored to a parent snapshot, and the WAL may be used to perform stored COW operations. As long as the source shared node still exists without modification, it is safe to replay the log record by copying the content of the source shared node out to the new run point node. The source shared node is immutable since it belongs to the read-only parent snapshot of the run point and cannot be removed until the parent snapshot that owns the source shared node is physically deleted.

In particular, the WAL may be replayed, after a failure has occurred of the system with the COW B+ tree in memory and not all writes flushed to storage to restore the COW B+ tree to its state prior to failure, to perform one or more COW operations that were stored in the WAL using the stored tuple. The physical disk address of the source shared node may be used to find the content of the source shared node. The physical disk address of the new run point node may be used copy the content of the source shared node to the run point, to execute the write I/O request of the COW operation to the new run point node, and to create a pointer in the run point to the new run point node. The physical disk address of the parent node may be used remove a pointer in the run point to the parent node. The one or more pointers in the parent node to the one or more child nodes of the parent node may be used to create a new pointer in the run point to the one or more child nodes, excluding the source shared node.

The metadata table and WAL may be used when the parent snapshot is to be deleted. In some embodiments, when the parent snapshot is to be deleted, the system will make sure the effect of any COW B+ tree operation with an LSN equal to or smaller than the lastCOWLSN in the metadata table record for the parent snapshot has been persisted. When a COW B+ tree operation is performed, changes to the COW B+ tree may be stored in memory. When the COW B+ tree operation is persisted, the operation is copied from the memory to a persistent non-volatile storage. In some embodiments, the lastCOWLSN is frozen so that no new COW operations are permitted until the snapshot is deleted. If a COW B+ tree operation with an LSN equal to or smaller than the lastCOWLSN has not been persisted, the system waits until the COW B+ tree operation has been completed before deleting the parent snapshot. In particular, when a copied out node allocated during the COW operation, indicated in the WAL record for the LSN, is persisted, then the parent snapshot can be deleted. Thus, loss of the data can be prevented. In some embodiments, log records for persisted COW B+ tree operation that do need to be replayed anymore can be truncated from the metadata table.

Though certain aspects described herein are described with respect to snapshot B+ trees, the aspects may be applicable to any suitable ordered data structure.

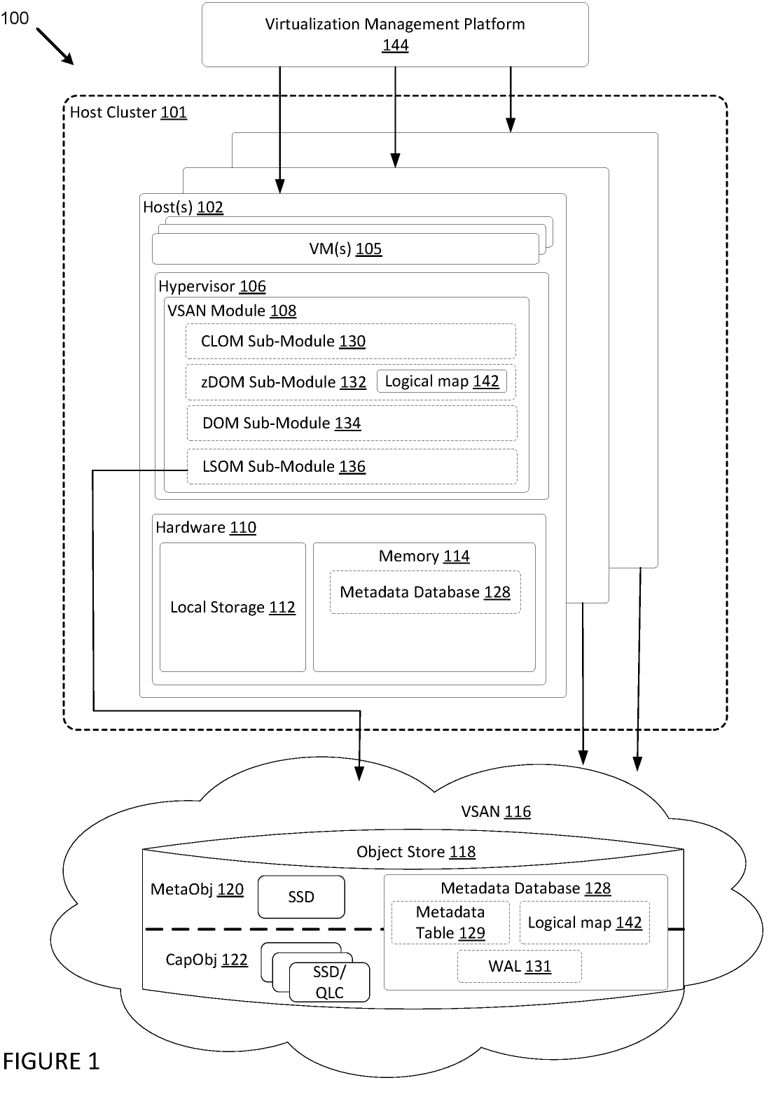

FIG. 1 is a diagram illustrating an example computing environment 100 in which embodiments may be practiced. As shown, computing environment 100 may include a distributed object-based datastore, such as a software-based “virtual storage area network” (VSAN) environment, VSAN 116, that leverages the commodity local storage housed in or directly attached (hereinafter, use of the term “housed” or “housed in” may be used to encompass both housed in or otherwise directly attached) to host(s) 102 of a host cluster 101 to provide an aggregate object storage to virtual machines (VMs) 105 running on the host(s) 102. The local commodity storage housed in the hosts 102 may include combinations of solid state drives (SSDs) or non-volatile memory express (NVMe) drives, magnetic or spinning disks or slower/cheaper SSDs, or other types of storages.

Additional details of VSAN are described in U.S. Pat. No. 10,509,708, the entire contents of which are incorporated by reference herein for all purposes, and U.S. Pat. Application No. 17/181,476, the entire contents of which are incorporated by reference herein for all purposes.

As described herein, VSAN 116 is configured to store virtual disks of VMs 105 as data blocks in a number of physical blocks, each physical block having a PBA that indexes the physical block in storage. VSAN module 108 may create an “object” for a specified data block by backing it with physical storage resources of an object store 118 (e.g., based on a defined policy).

VSAN 116 may be a two-tier datastore, storing the data blocks in both a smaller, but faster, performance tier and a larger, but slower, capacity tier. The data in the performance tier may be stored in a first object (e.g., a data log that may also be referred to as a MetaObj 120) and when the size of data reaches a threshold, the data may be written to the capacity tier (e.g., in full stripes, as described herein) in a second object (e.g., CapObj 122) in the capacity tier. SSDs may serve as a read cache and/or write buffer in the performance tier in front of slower/cheaper SSDs (or magnetic disks) in the capacity tier to enhance I/O performance. In some embodiments, both performance and capacity tiers may leverage the same type of storage (e.g., SSDs) for storing the data and performing the read/write operations. Additionally, SSDs may include different types of SSDs that may be used in different tiers in some embodiments. For example, the data in the performance tier may be written on a single-level cell (SLC) type of SSD, while the capacity tier may use a quad-level cell (QLC) type of SSD for storing the data.

Each host 102 may include a storage management module (referred to herein as a VSAN module 108) in order to automate storage management workflows (e.g., create objects in MetaObj 120 and CapObj 122 of VSAN 116, etc.) and provide access to objects (e.g., handle I/O operations to objects in MetaObj 120 and CapObj 122 of VSAN 116, etc.) based on predefined storage policies specified for objects in object store 118.

A virtualization management platform 144 is associated with host cluster 101. Virtualization management platform 144 enables an administrator to manage the configuration and spawning of VMs 105 on various hosts 102. As illustrated in FIG. 1, each host 102 includes a virtualization layer or hypervisor 106, a VSAN module 108, and hardware 110 (which includes the storage (e.g., SSDs) of a host 102). Through hypervisor 106, a host 102 is able to launch and run multiple VMs 105. Hypervisor 106, in part, manages hardware 110 to properly allocate computing resources (e.g., processing power, random access memory (RAM), etc.) for each VM 105. Each hypervisor 106, through its corresponding VSAN module 108, provides access to storage resources located in hardware 110 (e.g., storage) for use as storage for virtual disks (or portions thereof) and other related files that may be accessed by any VM 105 residing in any of hosts 102 in host cluster 101.

VSAN module 108 may be implemented as a “VSAN” device driver within hypervisor 106. In such an embodiment, VSAN module 108 may provide access to a conceptual “VSAN” through which an administrator can create a number of top-level “device” or namespace objects that are backed by object store 118 of VSAN 116. By accessing application programming interfaces (APIs) exposed by VSAN module 108, hypervisor 106 may determine all the top-level file system objects (or other types of top-level device objects) currently residing in VSAN 116.

Each VSAN module 108 (through a cluster level object management or “CLOM” sub-module 130) may communicate with other VSAN modules 108 of other hosts 102 to create and maintain an in-memory metadata database 128 (e.g., maintained separately but in synchronized fashion in memory 114 of each host 102) that may contain metadata describing the locations, configurations, policies and relationships among the various objects stored in VSAN 116. Specifically, in-memory metadata database 128 may serve as a directory service that maintains a physical inventory of VSAN 116 environment, such as the various hosts 102, the storage resources in hosts 102 (e.g., SSD, NVMe drives, magnetic disks, etc.) housed therein, and the characteristics/capabilities thereof, the current state of hosts 102 and their corresponding storage resources, network paths among hosts 102, and the like. In-memory metadata database 128 may further provide a catalog of metadata for objects stored in MetaObj 120 and CapObj 122 of VSAN 116 (e.g., what virtual disk objects exist, what component objects belong to what virtual disk objects, which hosts 102 serve as “coordinators” or “owners” that control access to which objects, quality of service requirements for each object, object configurations, the mapping of objects to physical storage locations, etc.).

In-memory metadata database 128 is used by VSAN module 108 on host 102, for example, when a user (e.g., an administrator) first creates a virtual disk for VM 105 as well as when VM 105 is running and performing I/O operations (e.g., read or write) on the virtual disk.

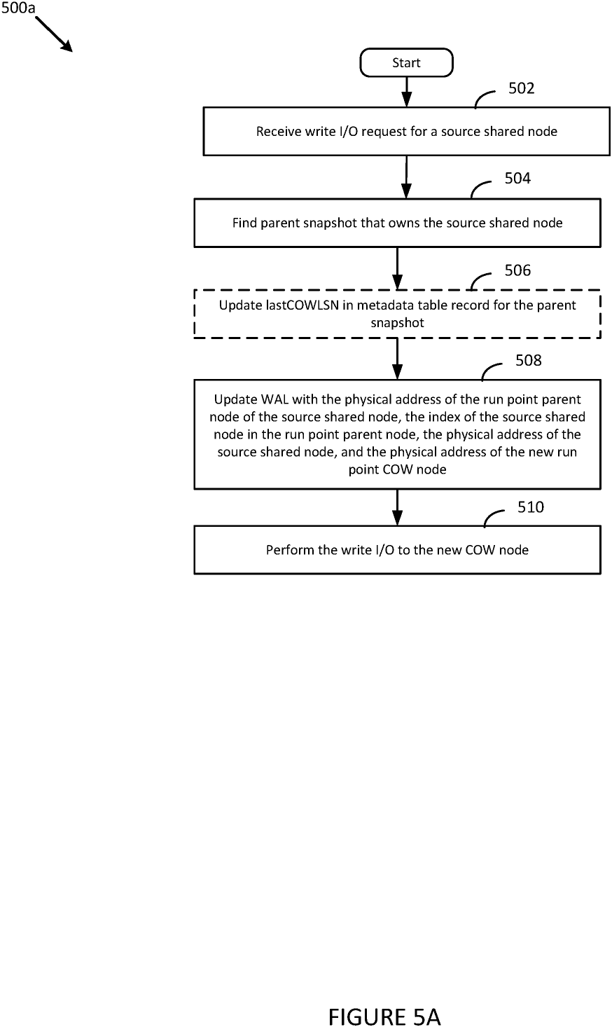

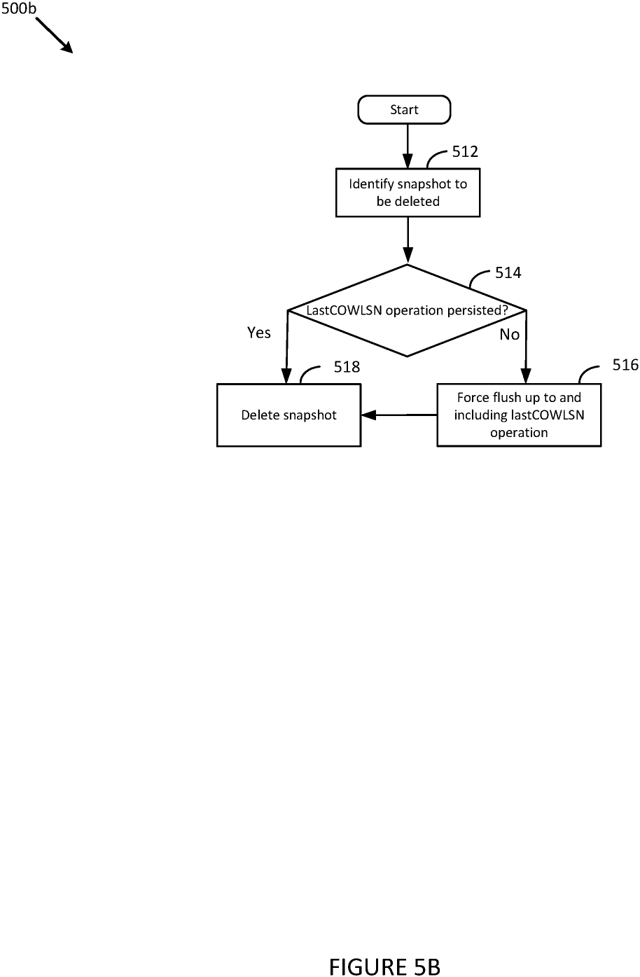

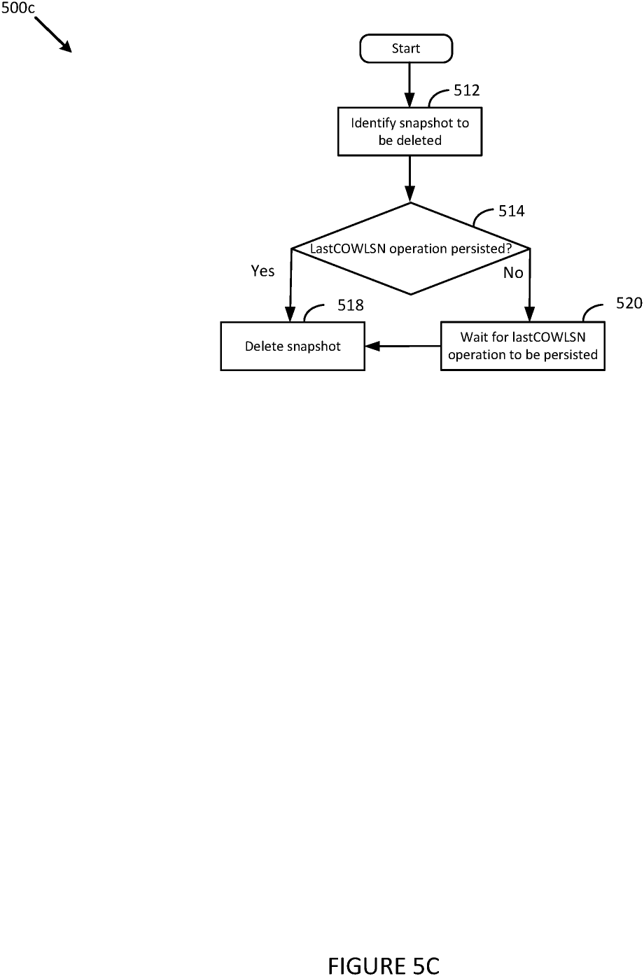

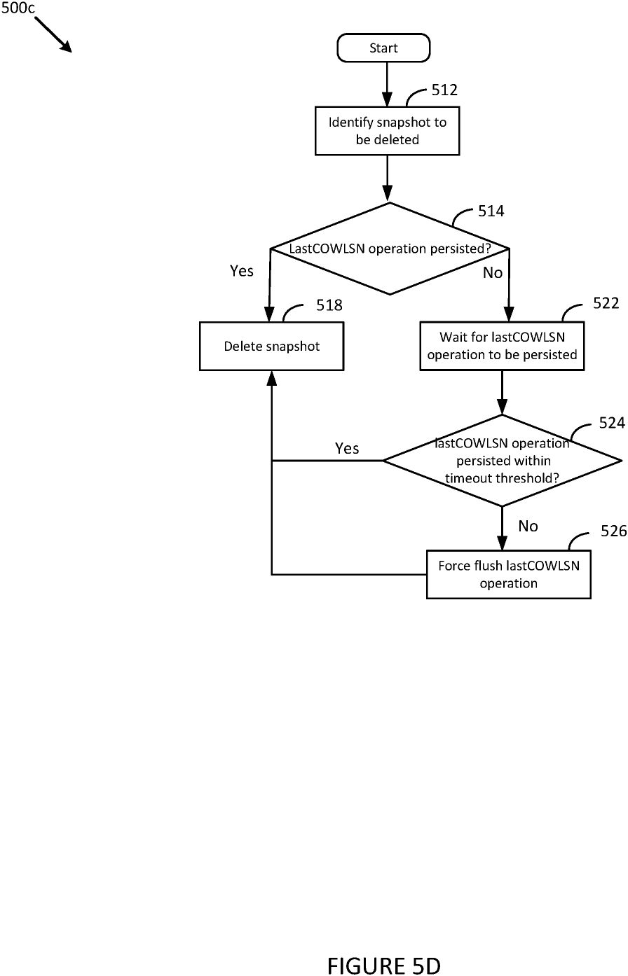

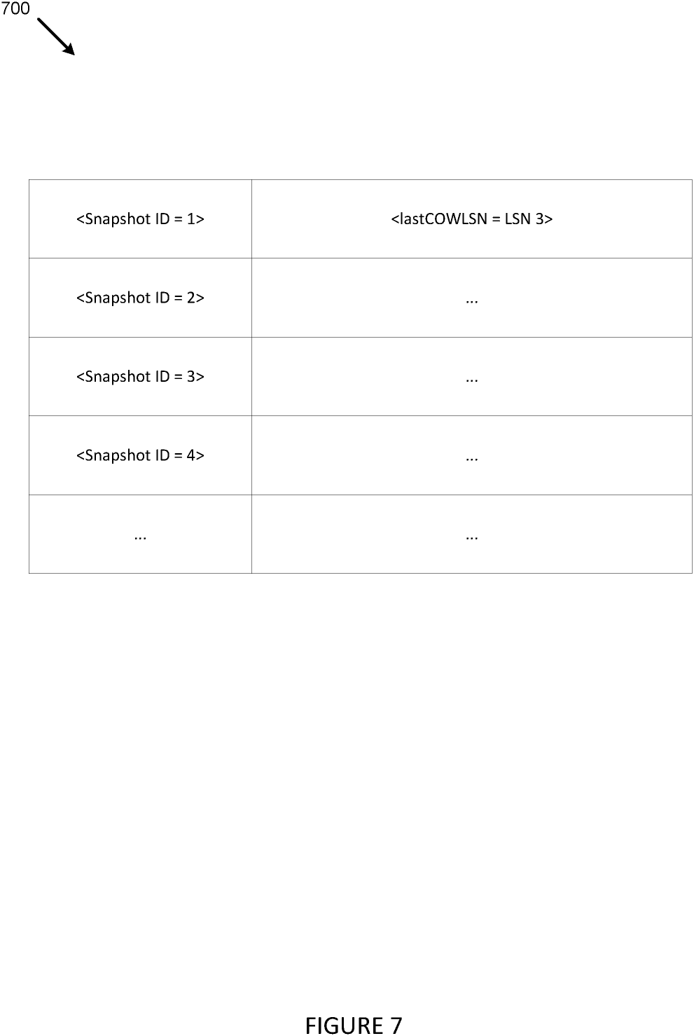

In certain embodiments, in-memory metadata database 128 may include a WAL 131. As described in more detail below with respect to FIGS. 5 and 7, WAL 131 may maintain tuples associated with COW B+ tree operations, including the physical disk address of the run point parent node of the source shared node, the index of the child source shared node in the run point parent node, the physical disk address of the originally source shared node, and the physical disk address of the new copied out node allocated during the COW operation. WAL 131 may be replayed for crash recovery.

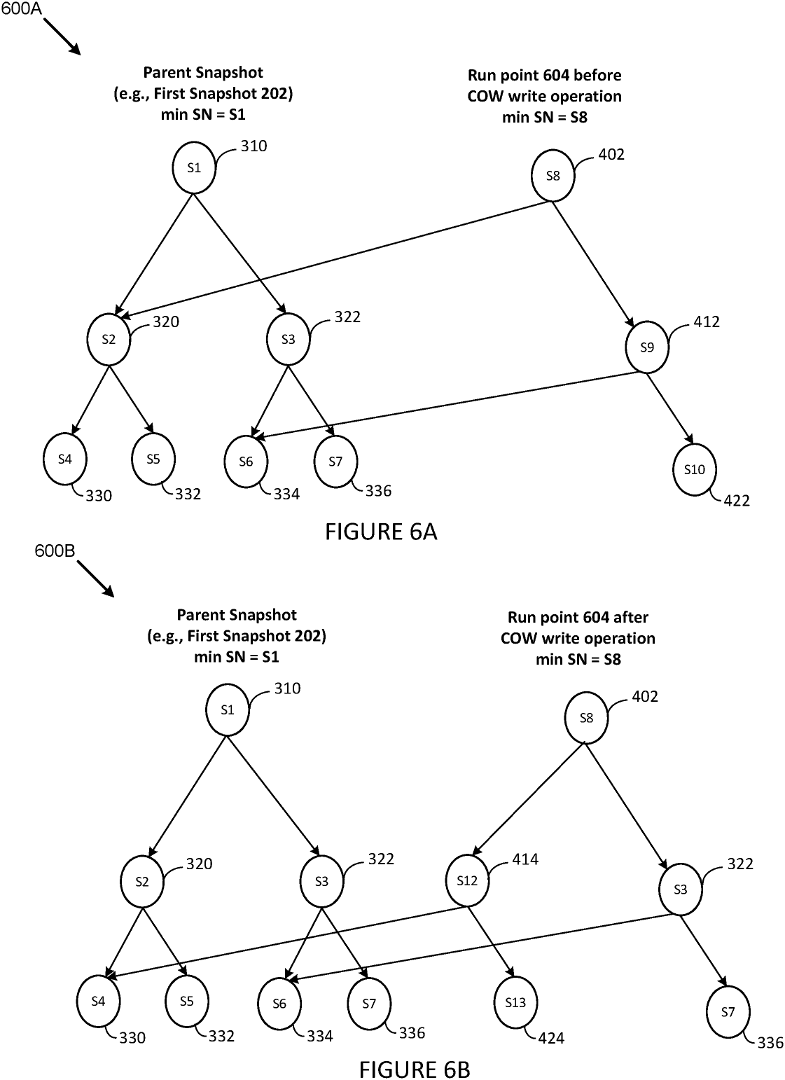

In certain embodiments, in-memory metadata database 128 may include a metadata table 129. As described in more detail below with respect to FIGS. 5-6, metadata table 129 may maintain the last COW operation LSN at the snapshot that owns the source shared node associated with the COW operation. The last COW operation LSN may be used to determine whether a snapshot can be deleted based on whether the last COW operation for the snapshot has been completed.

VSAN module 108, by querying its local copy of in-memory metadata database 128, may be able to identify a particular file system object (e.g., a virtual machine file system (VMFS) file system object) stored in object store 118 that may store a descriptor file for the virtual disk. The descriptor file may include a reference to a virtual disk obj ect that is separately stored in object store 118 of VSAN 116 and conceptually represents the virtual disk (also referred to herein as composite object). The virtual disk object may store metadata describing a storage organization or configuration for the virtual disk (sometimes referred to herein as a virtual disk “blueprint”) that suits the storage requirements or service level agreements (SLAs) in a corresponding storage profile or policy (e.g., capacity, availability, IOPs, etc.) generated by a user (e.g., an administrator) when creating the virtual disk.

The metadata accessible by VSAN module 108 in in-memory metadata database 128 for each virtual disk object provides a mapping to or otherwise identifies a particular host 102 in host cluster 101 that houses the physical storage resources (e.g., slower/cheaper SSDs, magnetics disks, etc.) that actually stores the physical disk of host 102.

As discussed in more detail below with respect to FIGS. 5, 6A, and 6B, VSAN module 108 may be configured to determine the parent snapshot that owns a source shared node when a write I/O request is received for the source shared node. Before executing the write I/O, VSAN module 108 may be configured to update metadata table 129 with the LSN of the COW operation at a record for the parent snapshot that owns the source shared node. Before executing the write I/O, VSAN module 108 may be configured to store a tuple at the log record for the LSN of the COW operation in WAL 131. When the parent snapshot is to be deleted, VSAN module 108 may wait until the COW operation is completed before deleting the parent snapshot.

Various sub-modules of VSAN module 108, including, in some embodiments, CLOM sub-module 130, distributed object manager (DOM) sub-module 134, zDOM sub-module 132, and/or local storage object manager (LSOM) sub-module 136, handle different responsibilities. CLOM sub-module 130 generates virtual disk blueprints during creation of a virtual disk by a user (e.g., an administrator) and ensures that objects created for such virtual disk blueprints are configured to meet storage profile or policy requirements set by the user. In addition to being accessed during object creation (e.g., for virtual disks), CLOM sub-module 130 may also be accessed (e.g., to dynamically revise or otherwise update a virtual disk blueprint or the mappings of the virtual disk blueprint to actual physical storage in object store 118) on a change made by a user to the storage profile or policy relating to an object or when changes to the cluster or workload result in an object being out of compliance with a current storage profile or policy.

In one embodiment, if a user creates a storage profile or policy for a virtual disk object, CLOM sub-module 130 applies a variety of heuristics and/or distributed algorithms to generate a virtual disk blueprint that describes a configuration in host cluster 101 that meets or otherwise suits a storage policy. The storage policy may define attributes such as a failure tolerance, which defines the number of host and device failures that a VM can tolerate. A redundant array of inexpensive disks (RAID) configuration may be defined to achieve desired redundancy through mirroring and access performance through erasure coding (EC). EC is a method of data protection in which each copy of a virtual disk object is partitioned into stripes, expanded and encoded with redundant data pieces, and stored across different hosts 102 of VSAN 116 datastore. For example, a virtual disk blueprint may describe a RAID 1 configuration with two mirrored copies of the virtual disk (e.g., mirrors) where each are further striped in a RAID 0 configuration. Each stripe may contain a plurality of data blocks (e.g., four data blocks in a first stripe). Including RAID 5 and RAID 6 configurations, each stripe may also include one or more parity blocks. Accordingly, CLOM sub-module 130, may be responsible for generating a virtual disk blueprint describing a RAID configuration.

CLOM sub-module 130 may communicate the blueprint to its corresponding DOM sub-module 134, for example, through zDOM sub-module 132. DOM sub-module 134 may interact with objects in VSAN 116 to implement the blueprint by allocating or otherwise mapping component objects of the virtual disk object to physical storage locations within various hosts 102 of host cluster 101. DOM sub-module 134 may also access in-memory metadata database 128 to determine the hosts 102 that store the component objects of a corresponding virtual disk object and the paths by which those hosts 102 are reachable in order to satisfy the I/O operation. Some or all of metadata database 128 (e.g., the mapping of the object to physical storage locations, etc.) may be stored with the virtual disk object in object store 118.

When handling an I/O operation from VM 105, due to the hierarchical nature of virtual disk objects in certain embodiments, DOM sub-module 134 may further communicate across the network (e.g., a local area network (LAN), or a wide area network (WAN)) with a different DOM sub-module 134 in a second host 102 (or hosts 102) that serves as the coordinator for the particular virtual disk object that is stored in local storage 112 of the second host 102 (or hosts 102) and which is the portion of the virtual disk that is subject to the I/O operation. If VM 105 issuing the I/O operation resides on a host 102 that is also different from the coordinator of the virtual disk object, DOM sub-module 134 of host 102 running VM 105 may also communicate across the network (e.g., LAN or WAN) with the DOM sub-module 134 of the coordinator. DOM sub-modules 134 may also similarly communicate amongst one another during object creation (and/or modification).

Each DOM sub-module 134 may create their respective objects, allocate local storage 112 to such objects, and advertise their objects in order to update in-memory metadata database 128 with metadata regarding the object. In order to perform such operations, DOM sub-module 134 may interact with a local storage object manager (LSOM) sub-module 136 that serves as the component in VSAN module 108 that may actually drive communication with the local SSDs (and, in some cases, magnetic disks) of its host 102. In addition to allocating local storage 112 for virtual disk objects (as well as storing other metadata, such as policies and configurations for composite objects for which its node serves as coordinator, etc.), LSOM sub-module 136 may additionally monitor the flow of I/O operations to local storage 112 of its host 102, for example, to report whether a storage resource is congested.

zDOM sub-module 132 may be responsible for caching received data in the performance tier of VSAN 116 (e.g., as a virtual disk object in MetaObj 120) and writing the cached data as full stripes on one or more disks (e.g., as virtual disk objects in CapObj 122). To reduce I/O overhead during write operations to the capacity tier, zDOM may require a full stripe (also referred to herein as a full segment) before writing the data to the capacity tier. Data striping is the technique of segmenting logically sequential data, such as the virtual disk. Each stripe may contain a plurality of data blocks; thus, a full stripe write may refer to a write of data blocks that fill a whole stripe. A full stripe write operation may be more efficient compared to the partial stripe write, thereby increasing overall I/O performance. For example, zDOM sub-module 132 may do this full stripe writing to minimize a write amplification effect. Write amplification, refers to the phenomenon that occurs in, for example, SSDs, in which the amount of data written to the memory device is greater than the amount of information you requested to be stored by host 102. Write amplification may differ in different types of writes. Lower write amplification may increase performance and lifespan of an SSD.

In some embodiments, zDOM sub-module 132 performs other datastore procedures, such as data compression and hash calculation, which may result in substantial improvements, for example, in garbage collection, deduplication, snapshotting, etc. (some of which may be performed locally by LSOM sub-module 136 of FIG. 1).

In some embodiments, zDOM sub-module 132 stores and accesses an extent map 142. Extent map 142 provides a mapping of LBAs to PBAs, or LBAs to MBAs to PBAs. Each physical block having a corresponding PBA may be referenced by one or more LBAs. In certain embodiments, for each LBA, VSAN module 108, may store in a logical map of extent map 142, at least a corresponding PBA. The logical map may include an LBA to PBA mapping table. For example, the logical map may store tuples of <LBA, PBA>, where the LBA is the key and the PBA is the value. As used herein, a key is an identifier of data and a value is either the data itself or a pointer to a location (e.g., on disk) of the data associated with the identifier. In some embodiments, the logical map further includes a number of corresponding data blocks stored at a physical disk address that starts from the PBA (e.g., tuples of <LBA, PBA, number of blocks>, where LBA is the key). In some embodiments where the data blocks are compressed, the logical map further includes the size of each data block compressed in sectors and a compression size (e.g., tuples of <LBA, PBA, number of blocks, number of sectors, compression size>, where LBA is the key).

In certain other embodiments, for each LBA, VSAN module 108, may store in a logical map, at least a corresponding MBA, which further maps to a PBA in a middle map of extent map 142. In other words, extent map 142 may be a two-layer mapping architecture. A first map in the mapping architecture, e.g., the logical map, may include an LBA to MBA mapping table, while a second map, e.g., the middle map, may include an MBA to PBA mapping table. For example, the logical map may store tuples of <LBA, MBA>, where the LBA is the key and the MBA is the value, while the middle map may store tuples of <MBA, PBA>, where the MBA is the key and the PBA is the value.

In certain embodiments, the logical map of the two-layer snapshot extent mapping architecture is a B+ tree. B+ trees are used as data structures for storing the metadata. A B+ tree is a multi-level data structure having a plurality of nodes, each node containing one or more key-value pairs. In this case, the key-value pairs may include tuples of <LBA, MBA> mappings stored in the logical map.

Logical maps may also be used in snapshot mapping architecture. Modern storage platforms, including VSAN 116, may enable snapshot features for backup, archival, or data protections purposes. Snapshots provide the ability to capture a point-in-time state and data of a VM 105 to not only allow data to be recovered in the event of failure but restored to known working points. Snapshots may capture VMs′ 105 storage, memory, and other devices, such as virtual network interface cards (NICs), at a given point in time. Snapshots do not require an initial copy, as they are not stored as physical copies of data blocks (at least initially), but rather as pointers to the data blocks that existed when the snapshot was created. Because of this physical relationship, a snapshot may be maintained on the same storage array as the original data.

As mentioned, snapshots collected over two or more backup sessions may create a snapshot hierarchy where snapshots are connected in a branch tree structure with one or more branches. Snapshots in the hierarchy have parent-child relationships with one or more other snapshots in the hierarchy. In linear processes, each snapshot has one parent snapshot and one child snapshot, except for the last snapshot, which has no child snapshots. Each parent snapshot may have more than one child snapshot. Additional snapshots in the snapshot hierarchy may be created by reverting to the current parent snapshot or to any parent or child snapshot in the snapshot tree to create more snapshots from that snapshot. Each time a snapshot is created by reverting to any parent or child snapshot in the snapshot tree, a new branch in the branch tree structure is created. The current state of a storage volume is referred to as the “run point”.

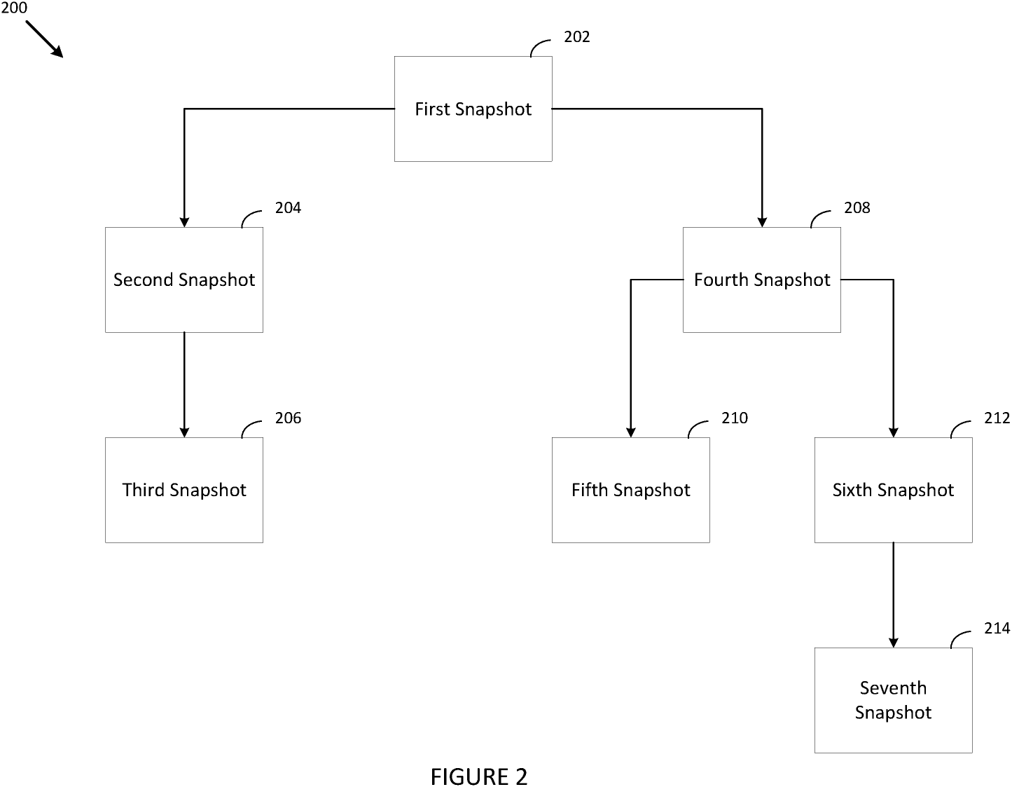

FIG. 2 is a block diagram illustrating an example snapshot hierarchy 200, according to an example embodiment of the present disclosure. As shown in FIG. 2, seven snapshots may exist in snapshot hierarchy 200. A first snapshot 202 may be a snapshot created first in time. First snapshot 202 may be referred to as a root snapshot of the snapshot hierarchy 200, as first snapshot 202 does not have any parent snapshots. First snapshot 202 may further have two child snapshots: second snapshot 204 and fourth snapshot 208. Fourth snapshot 208 may have been created after reverting back to first snapshot 202 in snapshot hierarchy 200, thereby creating an additional branch from first snapshot 202 to fourth snapshot 208. Second snapshot 204 and fourth snapshot 208 may be considered sibling snapshots. Second snapshot 204 and fourth snapshot 208 may not only be child snapshots of first snapshot 202 but also parent snapshots of other snapshots in snapshot hierarchy 200. In particular, second snapshot 204 may be a parent of third snapshot 206, and fourth snapshot 208 may be a parent of both fifth snapshot 210 and sixth snapshot 212. Third snapshot 206, fifth snapshot 210, and sixth snapshot 212 may be considered grandchildren snapshots of first snapshot 202. Third snapshot 206 and fifth snapshot 210 may not have any children snapshots; however, sixth snapshot 212 may have a child snapshot, seventh snapshot 214. Seventh snapshot 214 may not have any children snapshots in snapshot hierarchy 200.

While FIG. 2 illustrates only seven snapshots in snapshot hierarchy 200, any number of snapshots may be considered as part of a snapshot hierarchy. Further, any parent-child relationships between the snapshots in the snapshot hierarchy may exist in addition to, or alternative to, the parent-child relationships illustrated in FIG. 2.

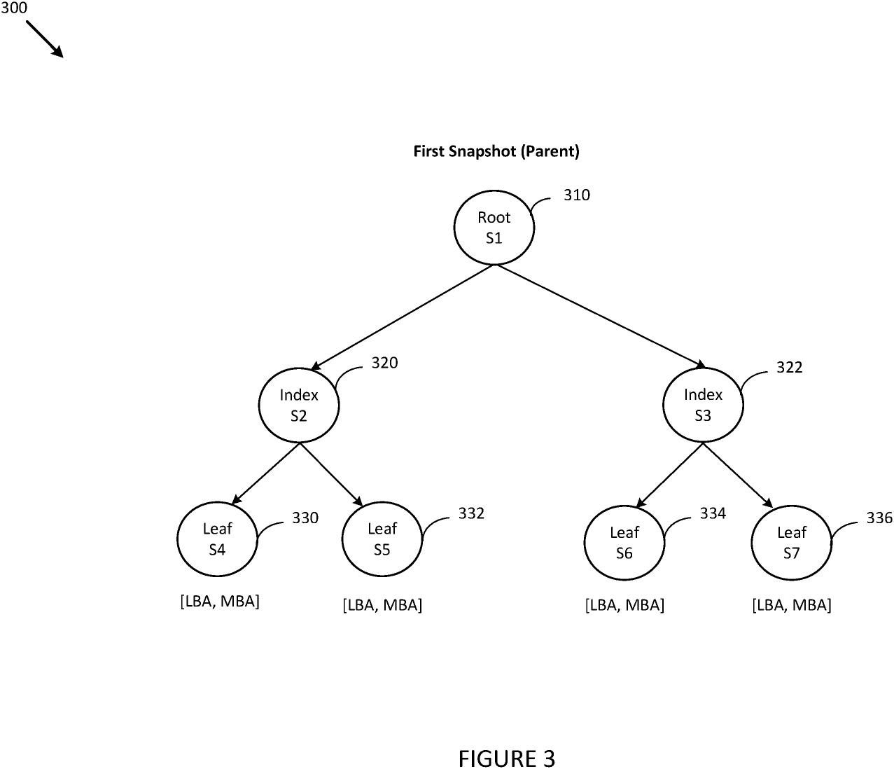

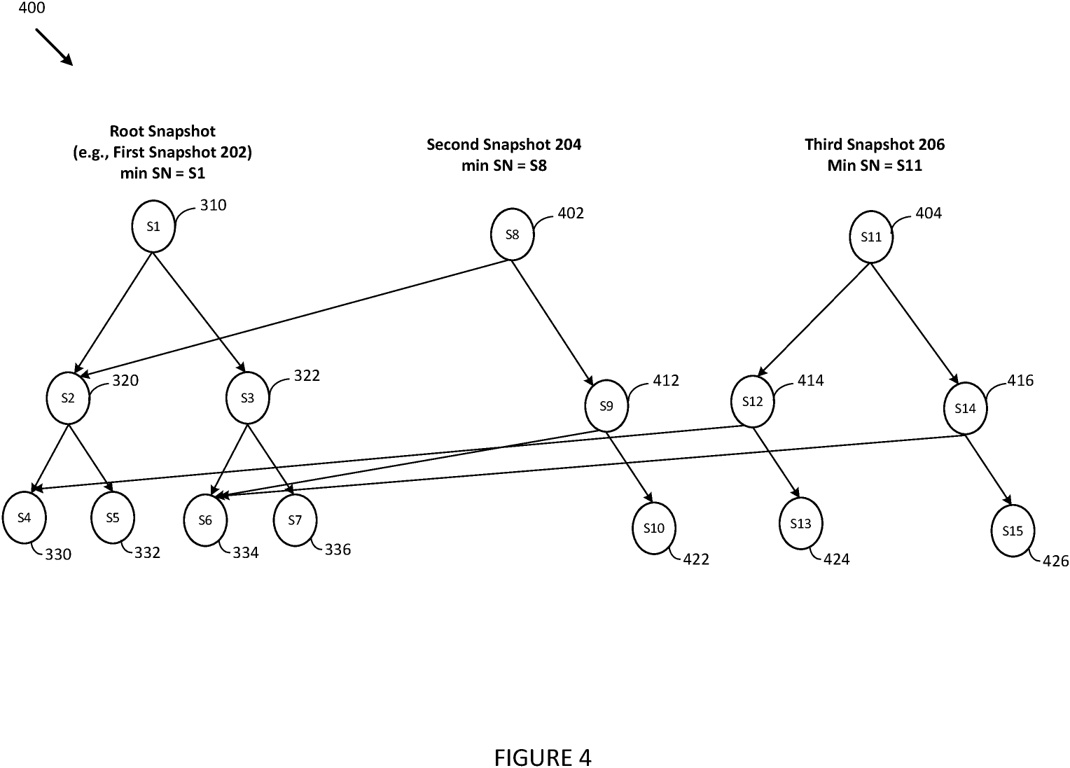

As mentioned above, VSAN module 108 may be configured to handle I/Os. Client write I/Os are written to the run point while the snapshots may be read-only. In some embodiments, a snapshot may be configured as a write-able snapshot. Such snapshots, however, effectively operate as a run point and may be handled as running points for the techniques described herein. For a COW operation, the source shared node page is copied-out when there is a new write to the source shared node. The source nodes page to be copied out may be owned by a parent snapshot of the run point. In some embodiments, VSAN module 108 updates only the record in metadata table 129 for the parent snapshot to reflect the LSN of the COW operation. Thus, VSAN module 108 may be configured to determine the parent snapshot that owns a source shared node when a write I/O request is received. FIGS. 3-4 illustrates ownership of shared nodes in a B+ tree data structure.

FIG. 3 is a block diagram illustrating a B+ tree 300 data structure, according to an example embodiment of the present application. For illustrative purposes, B+ tree 300 may represent the logical map B+ tree for the root snapshot (e.g., first snapshot 202) in snapshot hierarchy 200.

As illustrated, B+ tree 300 may include a plurality of nodes connected in a branching tree structure. The top node of a B+ tree may be referred as a root node, e.g., root node 310, which has no parent node. The middle level of B+ tree 300 may include index nodes 320 and 322 (also referred to as “index” nodes), which may have both a parent node and one or more child nodes. In the illustrated example, B+ tree 300 has only three levels, and thus only a single middle level, but other B+ trees may have more middle levels and thus greater heights. The bottom level of B+ tree 300 may include leaf nodes 330-336 which do not have any more children nodes. In the illustrated example, in total, B+ tree 300 has seven nodes, two levels, and a height of three. Root node 310 is in level two of the tree, middle (or index) nodes 320 and 322 are in level one of the tree, and leaf nodes 330-336 are in level zero of the tree.

Each node of B+ tree 300 may store at least one tuple. In a B+ tree, leaf nodes may contain data values (or real data) and middle (or index) nodes may contain only indexing keys. For example, each of leaf nodes 330-336 may store at least one tuple that includes a key mapped to real data, or mapped to a pointer to real data, for example, stored in a memory or disk. As shown in FIG. 3, these tuples may correspond to key-value pairs of <LBA, MBA> or <LBA, PBA> mappings for data blocks associated with each LBA. In some embodiments, each leaf node may also include a pointer to its sibling(s), which is not shown for simplicity of description. On the other hand, a tuple in the middle and/or root nodes of B+ tree 300 may store an indexing key and one or more pointers to its child node(s), which can be used to locate a given tuple that is stored in a child node.

Because B+ tree 300 contains sorted tuples, a read operation such as a scan or a query to B+ tree 300 may be completed by traversing the B+ tree relatively quickly to read the desired tuple, or the desired range of tuples, based on the corresponding key or starting key.

Each node of B+ tree 300 may be assigned a monotonically increasing SN. For example, a node with a higher SN may be a node which was created later in time than a node with a smaller SN. As shown in FIG. 3, root node 310 may be assigned an SN of S1 as root node 310 belongs to the root snapshot (e.g., first snapshot 202 illustrated in FIG. 2, created first in time) and was the first node created for the root snapshot. Other nodes of B+ tree 300 may similarly be assigned an SN, for example, node 320 may be assigned S2, index node 322 may be assigned S3, node 330 may be assigned S4, and so forth.

In certain embodiments, the logical map B+ tree for the snapshots in a snapshot hierarchy may be a COW B+ tree (also referred to as an append-only B+ tree). When a COW approach is taken and a child snapshot is created, instead of copying the entire logical map B+ tree of the parent snapshot, the child snapshot shares with the parent snapshot and, in some cases, ancestor snapshots, one or more extents by having a B+ tree index node, exclusively owned by the child snapshot, point to shared parent and/or ancestor nodes. This COW approach for the creation of a child B+ tree may be referred to as a “lazy copy approach” as the entire logical map of the parent snapshot is not copied when creating the child snapshot.

FIG. 4 is a block diagram illustrating a B+ tree data structure 400 using a COW approach for the creation of logical maps for child snapshots in a snapshot hierarchy, according to an example embodiment of the present application. For illustrative purposes, B+ tree data structure 400 may represent the B+ tree logical maps for first snapshot 202, second snapshot 204, and third snapshot 206 in snapshot hierarchy 200. Fourth snapshot 208, fifth snapshot 210, sixth snapshot 212, and seventh snapshot 214 have been removed from the illustration of FIG. 4 for simplicity. However, B+ tree logical maps for fourth snapshot 208, fifth snapshot 210, sixth snapshot 212, and seventh snapshot 214 may exist in a similar manner as B+ tree logical maps described for first snapshot 202, second snapshot 204, and third snapshot 206 in FIG. 4.

As shown in FIG. 4, index node 320 and leaf node 334 are shared by root node 310 of a first B+ tree logical map (e.g., associated with first snapshot 202) and root node 402 of a second B+ tree logical map (e.g., associated with second snapshot 204, which is a child snapshot of first snapshot 202) generated from the first B+ tree logical map. This way, the two root nodes 310 and 402 may share the data of the tree without having to duplicate the entire data of the tree.

More specifically, when the B+ tree logical map for second snapshot 204 was created, the B+ tree logical map for first snapshot 202 was copied and snapshot data for leaf node 336 was overwritten, while leaf nodes 330, 332, and 334 were unchanged. Accordingly, root node 402 in the B+ tree logical map for second snapshot 204 has a pointer to node 320 in the B+ tree logical map for first snapshot 202 for the shared nodes 320, 330, and 332, but, instead of root node 402 having a pointer to index node 322, index node 412 was created with a pointer to shared leaf node 334 (e.g., shared between first snapshot 202 and second snapshot 204) and a pointer to new leaf node 422, containing metadata for the overwritten data block. Similar methods may have been used to create the B+ tree logical map for third snapshot 206 illustrated in FIG. 4.

As mentioned, each node in B+ tree data structure 400 may be assigned a monotonically increasing SN for purposes of checking the metadata consistency of snapshots in B+ tree data structure 400, and more specifically, in snapshot hierarchy 200. Further, the B+ tree logical map for each snapshot in B+ tree data structure 400 may be assigned a min SN, where the min SN is equal to a smallest SN value among all nodes owned by the snapshot. For example, in the example B+ tree data structure 400, first snapshot 202 may own nodes S1-S7; thus, the min SN assigned to the B+ tree logical map of first snapshot 202 may be equal to S1. Similarly, second snapshot 204 may own nodes S8-S10; thus, the min SN of the B+ tree logical map of second snapshot 204 may be equal to S8, and third snapshot 206 may own node S11-S15; thus, the min SN of the B+ tree logical map of third snapshot 206 may be equal to S11.

Accordingly, each node, in the B+ tree logical map of child snapshots 204 and 206 snapshot, whose SN is smaller than the min SN assigned to the B+ tree logical of the snapshot, may be a node that is not owned by the snapshot, but instead shared with a B+ tree logical map of an ancestor snapshot. For example, when traversing through the B+ tree logical map of second snapshot 204, node 320 may be reached. Because node 320 is associated with an SN less than the min SN of second snapshot 204 (e.g., S2 < S8), node 320 may be determined to be a node that is not owned by second snapshot 204, but instead owned by first snapshot 202 and shared with second snapshot 204. On the other hand, each node, in the B+ tree logical map of child snapshots 204 and 206 snapshot, whose SN is larger than the min SN assigned to the snapshot, may be a node that is owned by the snapshot. For example, when traversing through the B+ tree logical map of second snapshot 204, node 412 may be reached. Because node 412 is associated with an SN greater than the min SN of second snapshot 204 (e.g., S9 > S8), node 412 may be determined to be a node that is owned by second snapshot 204. Such rules may be true for all nodes belonging to each of the snapshot B+ tree logical maps created for a snapshot hierarchy, such as snapshot hierarchy 200 illustrated in FIG. 2.

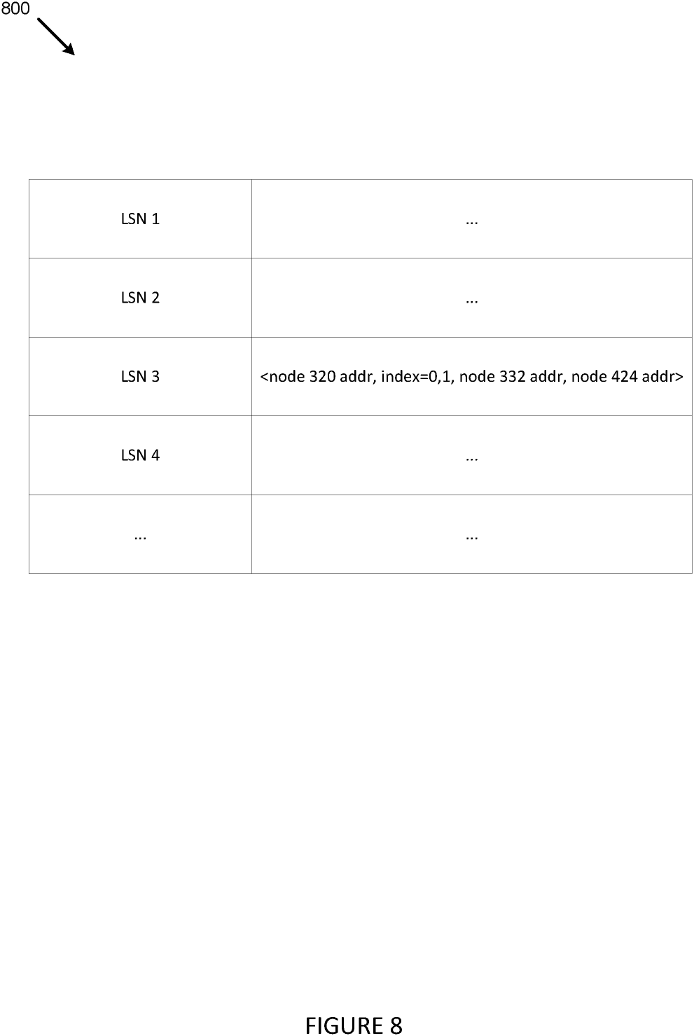

FIG. 5A is a work flow 500a for a COW B+ tree operation, according to an example embodiment of the present application. In some embodiments, work flow 500a may be performed by one or more components shown in FIG. 1. In some embodiments, work flow 500 may be performed by VSAN module 108. Work flow 500a may be understood with reference to FIG. 4 discussed above, and FIGS. 7 and 8. FIG. 7 illustrates an example COW B+ tree metadata table 700, according to an example embodiment of the present disclosure. FIG. 8 illustrates an example COW B+ tree WAL 800, according to an example embodiment of the present disclosure.

Work flow 500a may be used to perform a COW B+ tree write operation with reduced overhead, while preserving data correctness. Work flow 500 may be described with respect to an illustrative example in FIGS. 6A and 6B.

FIG. 6A illustrates an example B+ tree structure 600A with a run point and parent snapshot before executing a COW operation, according to an example embodiment of the present application. FIG. 6A corresponds to first snapshot 202 and second snapshot 204 illustrated in FIG. 4, where a COW B+ tree write operation is received for leaf node 332 (i.e., leaf node 332 is the source shared node in the COW operation), where second snapshot 204 is considered the run point 604 when the COW B+ tree operation is performed.

FIG. 6B illustrates an example B+ tree structure 600B with run point 604 and parent snapshot after executing the COW operation, according to an example embodiment of the present application. As shown in FIG. 6B, for the COW operation to source shared node 332, a pointer to parent node 320 is removed from root node 402 in run point 604. A new index node 414 is created and includes a pointer to shared node 330 and to new node 424, where new node 424 is created by copying node 332 and the write I/O is executed to new node 424.

Returning to FIG. 5, as mentioned, aspects of the present application provide efficient COW operations that reduce size of a WAL and guarantee data correctness. Work flow 500a may begin, at block 502, by receiving a write I/O request for a source shared node. In the illustrative example, VSAN module 108 receives a write I/O request for an LBA associated with leaf node 332, where the write I/O request has an assigned LSN 3.

At block 504, VSAN module 108 finds the parent snapshot that owns the source shared node. In the illustrative example, VSAN module 108 determine that node 332 is owned by first snapshot 202 based on node 332 having a SN, S4, smaller than the min SN, S8, of second snapshot 204, and larger than the min SN, S1, of first snapshot 202.

At block 506, VSAN module 108 may update the metadata table 129 record for the parent snapshot with the lastCOWLSN. In the illustrative example, VSAN module 108 updates the record for first snapshot 202, <snapshot ID = 1>, in metadata table 700 with the assigned LSN of the received write I/O request, LSN 3, as the lastCOWLSN, as shown in FIG. 7. Although the illustrated example shows an entry in metadata table 700 for a COW operation to node 332 in first snapshot 202, additionally there may be COW operations associated with nodes owned by other snapshots, such as a snapshot with snapshot ID = 2, 3, or 4, and so on.

At block 508, VSAN module 108 updates WAL 131 with the physical disk address of the parent node 320 in run point 604 of the source shared node 332, a pointer to child node 330 (e.g., an index = 0) of the parent node and a pointer (e.g., an index = 1) to source shared node 332 in parent node 320, the physical disk address of source shared node 332, and the physical disk address of the new run point node 424 created by copying source shared node 332. In the illustrative example, VSAN module 108 records the COW B+ tree operation LSN 3 in WAL 800 along with the tuple <node 320, index=0,1, node 332 address, and node 424 address>, as shown in FIG. 8. In this example, node 332 is the source shared node, node 320 is the parent node of source shared node 332, index=0 is the pointer in parent 320 to child node 330, index=1 is the pointer in parent node 320 to the source shared node 332, and node 424 is the new copied out node. Accordingly, VSAN module 108 records the physical disk address of parent node 320, the index = 1 of the source shared node 332 in parent node 320, the physical disk address of source shared node 332, and the physical disk address of new copied out node 424, in WAL 800. Although the illustrated example shows an entry in WAL 800 for a COW operation with LSN = 3 to node 332, additionally there may be COW operations in WAL 800, such as COW operations with LSN =1, 2, and 3.

At block 510, VSAN module 108 performs the write I/O to the new COW node. In the illustrative example, after updating WAL 800 with the COW operation, VSAN module 108 performs the write I/O to the new copied out node 424.

In some embodiments, a snapshot may be deleted. A snapshot may be deleted manually (e.g., by an administrator of computing environment 100) or automatically (e.g., based on a configured life time for a snapshot). In some embodiments, VSAN module 108 truncates log records of the parent snapshot before deleting nodes exclusively owned by the parent snapshot. Because WAL 131 may have a limited size, WAL 131 may need to be truncated to free up space for new records. It may be assumed that when the lastCOWLSN operation has been persisted, earlier COW operations (e.g., having a smaller LSN) have already been persisted. Thus, in some embodiments, the write I/O cost to flush the updates in metadata table 129 is amortized for multiple COW operations. In some embodiments, WAL 131 may be truncated by removing the records with an LSN equal to or less than the lastCOWLSN of the snapshot being deleted.

FIG. 5B is a work flow 500b for deleting a snapshot in a COW B+ tree operation, according to an example embodiment of the present application. In some embodiments, work flow 500b may be performed by one or more components shown in FIG. 1. In some embodiments, work flow 500b may be performed by VSAN module 108. Work flow 500b may be understood with reference to FIGS. 5-8.

At block 512, VSAN module 108 identifies a snapshot to be deleted. In some embodiments, a snapshot has a configured lifetime after which the snapshot is deleted (e.g., 30 minutes). In some embodiments, VSAN module 108 may receive a command to delete a snapshot. In the illustrative example, VSAN module 108 determines to delete first snapshot 202.

At block 514, VSAN module 108 determine whether COW operations associated with the parent snapshot have been persisted. In some embodiments, VSAN module 108 determines whether all COW B+ tree operations with an LSN equal to or less than the lastCOWLSN in metadata table 129 record for the parent snapshot have been persisted. In the illustrative example, VSAN module 108 checks the lastCOWLSN, LSN 3, in metadata table 700 record for first snapshot 202, snapshot ID = 1, and determines whether all COW B+ operations in WAL 800 with an LSN equal to or less than LSN 3 have been persisted. For example, for the COW B+ tree operation, LSN 3, VSAN module 108 checks whether the new copied out node allocated during the COW operation, node 424, is persisted.

Where VSAN module 108 determines, at block 514, all COW B+ tree operations up to and including the lastCOWLSN operation have been persisted, then at block 518, VSAN module 108 deletes the parent snapshot. For example, where VSAN module 108 determines, at block 514, that all COW B+ tree operations in WAL 131 with an LSN equal to or smaller than the lastCOWLSN, LSN 3, in the metadata table 129 record for first snapshot 202 have been completed, VSAN module 108 then deletes first snapshot 202 at block 518.

Where VSAN module 108 determines, at block 514, a COW B+ tree operation with an LSN equal to or less than the lastCOWLSN has not been persisted, then at block 516, VSAN module 108 forces flush of the COW+ tree operations up to and including the lastCOWLSN. In the illustrative example, VSAN module 108 persists the write to node 424 and can then remove the record for LSN from WAL 800. For example, VSAN module 108 moves node 424 from memory to persistent non-volatile storage. Once VSAN module 108 forces flush of COW B+ tree operations up to and including the lastCOWLSN operation for the snapshot, then at block 518, VSAN module 108 deletes the snapshot.

Alternatively, as shown in workflow 500c, where VSAN module 108 determines, at block 514, a COW B+ tree operation with an LSN equal to or less than the lastCOWLSN has not been persisted, then at block 520, VSAN module 108 waits until the COW B+ tree operation has been persisted. In the illustrative example, VSAN module 108 waits until the write to node 424 has been persisted. After VSAN module 108 waits for the COW B+ tree operations up to and including the lastCOWLSN operation for the snapshot to be completed, then at block 518, VSAN module 108 deletes the snapshot.

In another alternative, as shown in workflow 500d, where VSAN module 108 determines, at block 514, a COW B+ tree operation with an LSN equal to or less than the lastCOWLSN has not been persisted, then at block 524, VSAN module 108 waits, for a timeout threshold period, for the COW B+ tree operation to be persisted. If the COW B+ tree operation is persisted within the timeout threshold period, at 528, VSAN module 108 deletes the snapshot at block 518. If the COW B+ tree operation is not persisted within the timeout threshold period, at 528, VSAN module 108 forces a flush of COW B+ tree operations up to and including the lastCOWLSN operation for the snapshot at block 526. Once VSAN module 108 forces flush of COW B+ tree operations up to and including the lastCOWLSN operation for the snapshot, then, at block 518, VSAN module 108 deletes the snapshot.

While a parent snapshot is being deleted, the lastCOWLSN of the parent snapshot may be updated for new write I/Os at the run point. In some embodiments, VSAN module 108 postpones deletion of the parent snapshot for a configured time period (e.g., 1 minute), to provide more amortization of write I/Os before being flushed and to help to reduce the possibility to trigger a separate dedicated log truncation, since the log might have been truncated naturally by the log size limitation after the timeout.

Although not shown in FIG. 5, VSAN module 108 may determine to replay WAL 131, such as in the event of a crash. In the illustrative example, for crash recovery, VSAN module 108 may restore the run point reflecting any changes that have been persisted prior to the crash. After restoring snapshot 204 to the run point, the state of the B+ tree may return to the state of run point 604 illustrated in FIG. 6A. VSAN module 108 may check WAL 800 and replay the COW operations recorded in WAL 800. In the illustrative example, VSAN module 108 replays the COW operations with the LSN 3. In particular, using the stored tuple for LSN 3 in wall 800, <PBA node 320, index=1, PBA node 332, PBA node 424>, VSAN module can find the physical disk address of source shared node 332, create node 424 in the run point by copying source shared node 332, remove a pointer in node 402 to parent node 320, and add a pointer in node 414 to shared node 330 and new node 424.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for copy on write (COW) write operations, the method comprising:
receiving a write request to a first node in an ordered data structure, wherein the write request is associated with a log sequence number (LSN);
determining a parent snapshot that owns the first node, wherein the first node is a node shared by both a run point and the parent snapshot;
copying the first node to create a third node owned by the run point in the ordered data structure;
updating a write ahead log (WAL) record, associated with LSN, with a physical disk address of a second node owned by the run point in the ordered data structure that is a parent node of the first node, a pointer to the first node in the second node, a physical disk address of the first node, and a physical disk address of the third node; and
executing the write to the third node.

2. The method of claim 1, further comprising updating a record associated with the parent snapshot, in a metadata table, with the LSN.

3. The method of claim 2, further comprising:
determining to delete the parent snapshot;
checking the record associated with the parent snapshot in the metadata table to identify the LSN;
determining whether the write associated with the LSN has been persisted; and one of:
deleting the parent snapshot based on a determination that the write associated with the LSN has been persisted; or
waiting until the write associated with the LSN has been persisted before deleting the parent snapshot based on a determination that the write associated with the LSN has not been persisted.

4. The method of claim 3, further comprising:
removing from the WAL one or more records associated with one or more LSNs equal to or less than an LSN value in the record associated with the parent snapshot in the metadata table.

5. The method of claim 4, further comprising:
after determining to delete the parent snapshot, waiting for a configured duration before deleting the parent snapshot;
during the duration:
receiving one or more additional write requests associated with one or more LSNs greater than the LSN; and
updating the record associated with the parent snapshot in the metadata table.

6. The method of claim 1, further comprising:
restoring the run point including changes in the ordered data structure that have been stored to persistent storage prior to restoring the run point, wherein the write request associated with the LSN has not been stored to the persistent storage when restoring the run point;
checking the WAL record associated with the LSN;
removing a pointer in a node of the restored run point to the physical disk address of the second node; and
copying the first node from the physical disk address of the first node to physical disk address of the third node.

7. The method of claim 6, wherein the WAL record further includes a pointer to another node that is a child of the second node, and further comprising:
identifying the other node that is a child of the second node based on the pointer; and
adding a pointer to other node in a node of the restored run point.

8. A system comprising:
one or more processors; and
at least one memory, the one or more processors and the at least one memory configured to:
receive a write request to a first node in an ordered data structure, wherein the write request is associated with a log sequence number (LSN);
determine a parent snapshot that owns the first node, wherein the first node is a node shared by both a run point and the parent snapshot;
copy the first node to create a third node owned by the run point in the ordered data structure;
update a write ahead log (WAL) record, associated with LSN, with a physical disk address of a second node owned by the run point in the ordered data structure that is a parent node of the first node, a pointer to the first node in the second node, a physical disk address of the first node, and a physical disk address of the third node; and
execute the write to the third node.

9. The system of claim 8, the one or more processors and the at least one memory further configured to:
update a record associated with the parent snapshot, in a metadata table, with the LSN.

10. The system of claim 9, the one or more processors and the at least one memory further configured to:
determine to delete the parent snapshot;
check the record associated with the parent snapshot in the metadata table to identify the LSN;
determine whether the write associated with the LSN has been persisted; and
one of:
delete the parent snapshot based on a determination that the write associated with the LSN has been persisted; or
wait until the write associated with the LSN has been persisted before deleting the parent snapshot based on a determination that the write associated with the LSN has not been persisted.

11. The system of claim 10, the one or more processors and the at least one memory further configured to:
remove from the WAL one or more records associated with one or more LSNs equal to or less than an LSN value in the record associated with the parent snapshot in the metadata table.

12. The system of claim 11, the one or more processors and the at least one memory further configured to:
after a determination to delete the parent snapshot, wait for a configured duration before deleting the parent snapshot;
during the duration:
receive one or more additional write requests associated with one or more LSNs greater than the LSN; and
update the record associated with the parent snapshot in the metadata table.

13. The system of claim 8, the one or more processors and the at least one memory further configured to:
restore the run point including changes in the ordered data structure that have been stored to persistent storage prior to restoring the run point, wherein the write request associated with the LSN has not been stored to the persistent storage when restoring the run point;
check the WAL record associated with the LSN;
remove a pointer in a node of the restored run point to the physical disk address of the second node; and
copy the first node from the physical disk address of the first node to physical disk address of the third node.

14. The system of claim 13, wherein the WAL record further includes a pointer to another node that is a child of the second node, and the one or more processors and the at least one memory are further configured to:
identify the other node that is a child of the second node based on the pointer; and
add a pointer to other node in a node of the restored run point.

15. A non-transitory computer-readable medium comprising instructions that, when executed by one or more processors of a computing system, cause the computing system to perform operations for copy on write (COW) write operations, the operations comprising:
receiving a write request to a first node in an ordered data structure, wherein the write request is associated with a log sequence number (LSN);
determining a parent snapshot that owns the first node, wherein the first node is a node shared by both a run point and the parent snapshot;
copying the first node to create a third node owned by the run point in the ordered data structure;
updating a write ahead log (WAL) record, associated with LSN, with a physical disk address of a second node owned by the run point in the ordered data structure that is a parent node of the first node, a pointer to the first node in the second node, a physical disk address of the first node, and a physical disk address of the third node; and
executing the write to the third node.

16. The non-transitory computer-readable medium of claim 15, the operations further comprising updating a record associated with the parent snapshot, in a metadata table, with the LSN.

17. The non-transitory computer-readable medium of claim 16, the operations further comprising:
determining to delete the parent snapshot;
checking the record associated with the parent snapshot in the metadata table to identify the LSN;
determining whether the write associated with the LSN has been persisted; and one of:
deleting the parent snapshot based on a determination that the write associated with the LSN has been persisted; or
waiting until the write associated with the LSN has been persisted before deleting the parent snapshot based on a determination that the write associated with the LSN has not been persisted.

18. The non-transitory computer-readable medium of claim 17, the operations further comprising:
removing from the WAL one or more records associated with one or more LSNs equal to or less than an LSN value in the record associated with the parent snapshot in the metadata table.

19. The non-transitory computer-readable medium of claim 18, the operations further comprising:
after determining to delete the parent snapshot, waiting for a configured duration before deleting the parent snapshot;
during the duration:
receiving one or more additional write requests associated with one or more LSNs greater than the LSN; and
updating the record associated with the parent snapshot in the metadata table.

20. The non-transitory computer-readable medium of claim 15, the operations further comprising:
restoring the run point including changes in the ordered data structure that have been stored to persistent storage prior to restoring the run point, wherein the write request associated with the LSN has not been stored to the persistent storage when restoring the run point;
checking the WAL record associated with the LSN;
removing a pointer in a node of the restored run point to the physical disk address of the second node; and
copying the first node from the physical disk address of the first node to physical disk address of the third node.
